(19) United States
(12) Patent Application Publication
(10) Pub. No.: US 2004/0125401 A1
(43) Pub. Date: Jul. 1, 2004

(54) System and method for printing on the nearest printer

(76) Inventors: David J. Earl, Cambridge (GB); Adrian Ford, Hertfordshire (GB)

Correspondence Address: DARBY & DARBY P.C., P. O. BOX 5257, NEW YORK, NY, 10150-5257, US

(21) Appl. No.: 10/632,540

(22) Filed: Jul. 31, 2003

Related U.S. Application Data
(60) Provisional application No. 60/400,077, filed on Jul. 31, 2002.

(51) Int. Cl. G06F 15/00; G06F 3/12

(52) U.S. Cl. 358/1.15; 358/1.13

(57) ABSTRACT

A system and method for simplifying the identification of and access to a networked printer that is located in close proximity to the networked computer of a user, wherein computer users are permitted to identify and designate a printer that is in close geographical proximity as “the nearest printer.”

### CROSS-REFERENCE TO RELATED APPLICATIONS

The invention relates to, and claims priority of, U.S. Provisional Patent Application Serial No. 60/400,077 filed on Jul. 31, 2002, having the same title as the present invention, which is incorporated herein by reference in its entirety.

### BACKGROUND OF THE INVENTION

1. Field of the Invention

The invention generally relates to the field of portable computers and, more particularly, to a system and method for printing on a nearest printer.

2. Description of the Related Art

Users of computers are becoming increasingly mobile. The associated computing equipment is also becoming smaller and more sophisticated. Portable computers are often now connected to a network, even when away from an associated home base. The connection may be via a phone line or high speed link in a hotel bedroom. Increasingly, mobile computers are networked more-or-less permanently via wireless links.

In such an environment, users naturally want to make use of familiar services, such as a printer for printing documents. Hotels, airport lounges and other public places already provide laser printers for the use of their customers. Currently, however, a user is generally required to plug the printer into their computer just as the user typically would in a fixed home environment. Users must also install the appropriate software for each such printer.

Most printers can also offer a network service, as is commonplace in the fixed office environment. Where there is a network connection between portable computer users and the printer (directly on the local area network into which a user is currently connected, or indirectly through the internet), users can generally print to that printer as if printing while in the office. However, printing in such a manner requires users to identify the printer on their computer prior to printing.

In conventional printing, this would require the addition of a new printer to the list of printers on the computers of the users and installation of the appropriate software for each kind of printer. This is a time consuming operation that is required at each location. The addition of a new printer to a list of printers on each computer causes clutter on the computers of the users; they may never use the particular printer again in the future. It also requires entering a significant amount of information to identify the printer that may not be easily available and can easily be entered incorrectly. Furthermore, the necessary software may not be readily available.

Electronics For Imaging Inc. has developed a system called PrintMe™. While this system provides for a registry of participating printers in a wide-area network, it still requires the knowledge of the identity and manual selection of the particular printer the user wishes to print to.

Furthermore, although PrintMe™ does not require installation of printer-specific printer drivers, this is achieved by requiring that printers are locally adapted or augmented with controllers that understand how to process print jobs directed to them across the wide-area network. In the system used by Electronics For Imaging PrintMe™, each participating printer is forced to observe a particular protocol such that a single driver that is installed once at the time of subscription can service all printers. However, this is undesirable because of the expense associated with the need to purchase an additional controller box that must be placed alongside each printer.

It is therefore apparent that there is a need for a method for simplifying the identification and use of a printer that is located in close proximity to a mobile computer user.

### BRIEF SUMMARY OF THE INVENTION

The present invention is a system and method for simplifying the identification of and access to a networked printer that is located in close proximity to the networked computer of a user. In accordance with the invention, computer users are able to automatically identify and designate a printer that is in close geographical proximity as “the nearest printer.”

A public registry that is accessible to both potential printer users and printer owners is maintained on the network by a server computer (or cluster of co-operating server computers) that is reached via the Internet. The registry stores information about each computer user subscribing to the system and each organization offering printing services. The registry also stores the geographical location (in a form suitable for comparison and plotting on a map, and in descriptive form useful to a person), along with the Internet address of each participating printer.

Further, the registry identifies who is permitted to use a participating printer. Such permission may be applied to groups or classes of users. This may be as broad as ‘anyone’ or as narrow as identifying individual subscribers.

Alternatively, permission may be granted to transient or temporary users. For example, when a subscriber checks-in to a participating hotel, registration can include assigning permission to use the hotel's public printers. This association would also be used to apply charges for the subscriber's use of the service to their hotel bill. Similarly, an airline can grant permission to any of their authorized lounge users so that they have access to print services at any of the company's lounges anywhere in the world.

When users want to print a document, they print to ‘the nearest printer.’ If there is more than one qualifying printer nearby, or if the nearest printer is located far away, they are asked to select or confirm which printer they want to use. When there is only one nearby printer, users are informed which printer they are using.

In all cases, users can obtain further information from the server about the printer location. This information can be in different forms, such as a plan, map or diagram. At this point, the users can choose to pause, or ask the server to pause so that they can move closer to the printer. One reason for the user to move closer to the printer is when the print job contains sensitive material they would not wish others to see or take as it is being printed.

The location of the user is determined by any suitable locator technology either built-in to their mobile computer, or carried by the user, such as computer-integrated Global Positioning Satellite (GPS) receivers, cell-phone triangulation, or the like. Manual location identification is also possible, either at the time of printing (‘United lounge at LAX’) or when some event occurs, such as when registering at a particular hotel. However, this is less desirable because of the lack of automation and the possibility for error introduced when manually entering information.

Printers usually remain in one location. Therefore, in certain embodiments of the invention, the location of a printer is entered manually when it is installed or occasionally moved. However, cell-phone and GPS technology is sufficiently cheap that it is viable for a suitably equipped printer to identify its location to the registry in a similar way to identifying the location of a subscriber.

In accordance with the invention, the printer owner registers the printer using a standard location-enabled device when standing in close proximity to the printer. In a manner similar to how the location of a subscriber is determined when requesting print services, the location of the printer is determined from the location of the printer registrant.

As a result, the server is able to assign the location of the printer being registered. When performed automatically, this is achieved by assuming the location of the registrant is sufficiently similar to the locator device. The location is recorded in the database by the server.

In accordance with the invention, upon identification of the printer by the server, the subscriber's print job is transferred from the mobile computer to the printer either directly across the local area network that both devices are connected to, or via the Internet, possibly via the server hosting the registry.

In another aspect of the invention, the need to install unique printer driver software for each printer encountered is eliminated. As a result, the printing task of the subscriber is further simplified.

In contrast to the system used by Electronics For Imaging PrintMe™, the system of the present invention permits the use of almost any printer. This is achieved through the mediation of the server. For each printer, the server additionally stores information about the type of printer. This information is determined either automatically or manually when the printer is installed. In accordance with the invention, when a user subscribes to the service, the user installs a single printer driver suitable for any use of the service. A print job is transmitted not to the printer, but rather to the server when the mobile computer creates a print job. The server translates the print job into a form that is suitable for the target printer, and then transmits the translated job to the printer on behalf of the user. Here, the form of the translated print job is determined based on the stored printer type information.

In certain embodiments, software on the mobile computer controls the transmission to the server, and encrypts the stream of data transmitted such that the document remains private. Here, software that receives the printer description in the network hosting the printer decrypts the translated job that arrives from the server.

In additional embodiments, the stored printer type information is extended to other details, such as the specific capabilities of a printer. As a result, when a subscriber prepares to print, they can be offered choices of how to print based on the capabilities of the printer. For example, a printer may offer duplex printing, i.e., the automatic printing of information on both sides of the sheets of paper. If this is the case, the user can be offered the opportunity to activate/deactivate such a feature in the same way as if the native software of the printer was permanently installed in the computer of the user.

### BRIEF DESCRIPTION OF THE DRAWINGS

The foregoing and other advantages and features of the invention will become more apparent from the detailed description of the preferred embodiments of the invention given below with reference to the accompanying drawings in which:

FIG. 1 is a schematic block diagram of an exemplary system in accordance with the invention;

FIG. 2 is an illustration of an exemplary web page through which an organization can add a printer to a register in accordance with the invention; and

FIG. 3 is a flowchart illustrating the steps of the method of the invention.

### DETAILED DESCRIPTION OF THE EXEMPLARY EMBODIMENTS

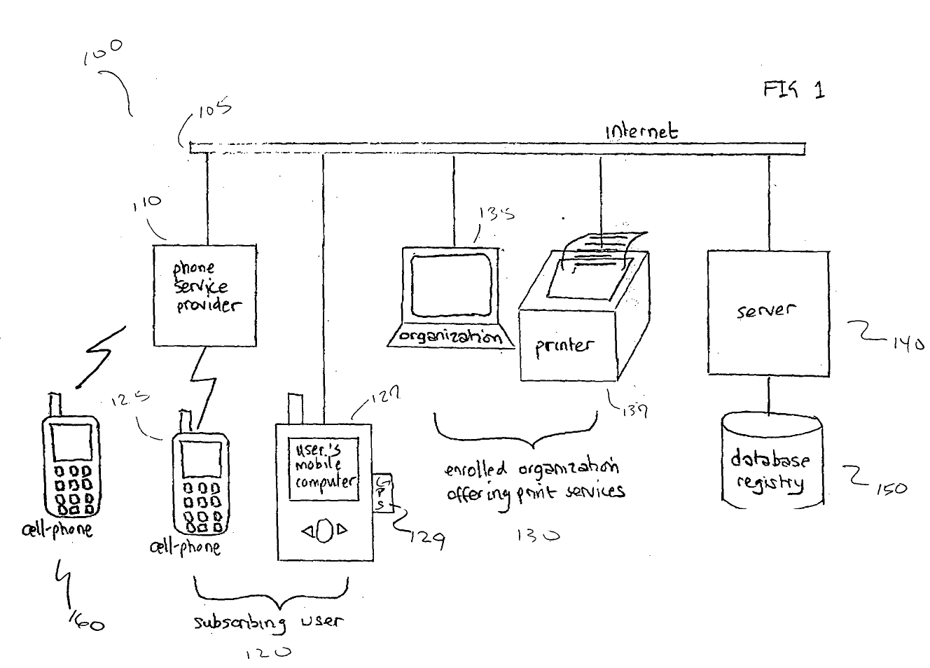

FIG. 1 is a schematic block diagram of an exemplary system 100 in accordance with the invention. As shown in FIG. 1, a database 150 of subscriber information is maintained on a server computer 140 or computers. In accordance with the invention, the database 150 of subscriber information is made accessible over the Internet 105 by way of web server software located on the server 140 in a manner that is known.

In accordance with the invention, an organization enrolls to offer print services. A representative of a subscriber organization 130 accesses the database 150 by way of a web browser that is located on any Internet-enabled computer 135 to enter the details of the organization that are then stored in the database 150, as well as to complete business-related tasks.

Once enrolled, an organization can add, move or remove printers 137 from a list of available printers as desired. Printer information in the database 150 is classified according to owning organization. Printer information is also collected together into groups of related printers. However, the kinds of relationships are not specified, merely that a relationship exists. The subscriber organization 130 can use the printer classifications and group collections to permit and later deny a user to print to any printer in the group. In certain embodiments, if an organization is a hotel chain, all the printers in any one hotel are grouped together such that when a user checks into a particular hotel, all of the printers that the hotel owns are made available to the user. In another embodiment, an airline permits access to color printers in their airline lounges only to high status frequent flyer club members.

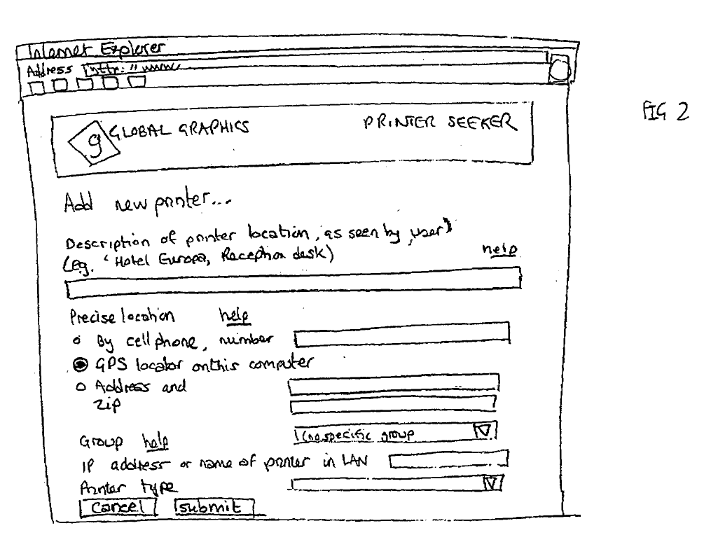

To add a printer 137 or a group of printers, the representative of the organization logs, into the server 140 via the Internet 105. This recalls the previously stored details of the organization and displays a page, such as the exemplary web page shown in FIG. 2, offering a variety of operations that can be performed, such as to preferably add a printer 147 or a group of printers.

To add a new group, the representative presses a button preferably labeled ‘add group.’ Here, the representative enters a name for the new group. In response, a record representing the new group is created in the database.

To add a printer 137, the representative presses a button preferably labeled ‘add printer’ and then provides printer details that are requested by the server. The type of printer 137 is chosen from a list of printers that is presented on the exemplary web page of FIG. 2. Along with this information, the Internet address of the printer is also supplied.

The actual geographic location of the printer is acquired in one of several possible ways. In one embodiment of the invention, the representative presses a button to transmit information to a server location that is obtained from a GPS receiver (not shown) built into the computer that they are using. Here, the server assumes that the representative and the GPS receiver are positioned near to the printer.

In alternative embodiments of the invention, the representative supplies the phone number of a cell-phone 160 operated by a service provider that is able to determine the location of the cell-phone 160. The server 140 then requests location information from the phone service provider 110 and assumes the phone is located near to the printer 137, and thereby determines the location of the printer. In another embodiment, the representative manually enters the address of the premises where the printer 137 is located.

In a further embodiment, the representative presses a suitable button on the control panel of a printer equipped with software and location sensing devices that are compatible with the system 100. The representative is then required to enter via the control panel an identifier for their organization, or printer group, and a pass-code. The printer 137 then transmits the required location of the printer, the type of printer, and Internet address of the printer. In certain embodiments, the group information is also transmitted to the server without the need for a separate computer.

In accordance with the contemplated embodiments, users requiring print services subscribe to the system. The users access the database 150 through a web browser on any Internet-enabled computer and enter their details that are then stored in the database 150.

Further, subscribers indicate their preferred method of location identification. This can be either by a GPS device 129 integrated in their portable computer 127, or a cell-phone 125 operated by a service provider 110 that is able to determine the location of the cell-phone. Here, the subscriber would provide the number of their cell-phone.

A single printer driver is also installed once by the subscriber on any of their computers through which they wish to print. The printer driver is downloaded from the server's web site, or by other methods that are known. For computers equipped with the Microsoft® Windows™ operating system, the download is achieved using the Add Printer dialog supplied with the operating system. In the contemplated embodiments, a subscriber does not identify a real printer when installing the printer driver, but rather a pseudo-printer is identified. That is, a stand-in for a real printer that is only identified when the subscriber decides to print.

As a result, two effects are obtained. First, the pseudo-printer is associated with the generic PostScript® language printer driver supplied with the operating system. Therefore, when subscribers print, a stream of PostScript® language page description data is generated that describes the appearance of the material they are printing. The means by which this is performed are well known in the art.

Second, a so-called port monitor (or equivalent, according to the operating system involved) is installed. For a real printer this would be the software that routes the page description to the printer. In the present contemplated embodiments of the invention, the print monitor provides a path for delivery of the page description to the server 140.

If subscribers identify themselves to an enrolled organization, the organization can inform the server via the Internet that the subscriber is temporarily or permanently authorized to use particular printers, groups of printers, or any of its printers. In certain embodiments, this task is automated by the organizations. In an exemplary embodiment where the printers are installed in a hotel chain, the loyalty scheme number of a guest offered on reservation or at check-in is used to consult their profile stored by the hotel chain. Here, the profile, which is managed by the guest, stores their printing services subscriber identity that is subsequently transmitted to the server 140 by the hotel chain's computer system on check-in to a specific hotel in the chain. This authorizes the use of that particular hotel's printer group for that subscriber. On check-out, authorization is withdrawn.

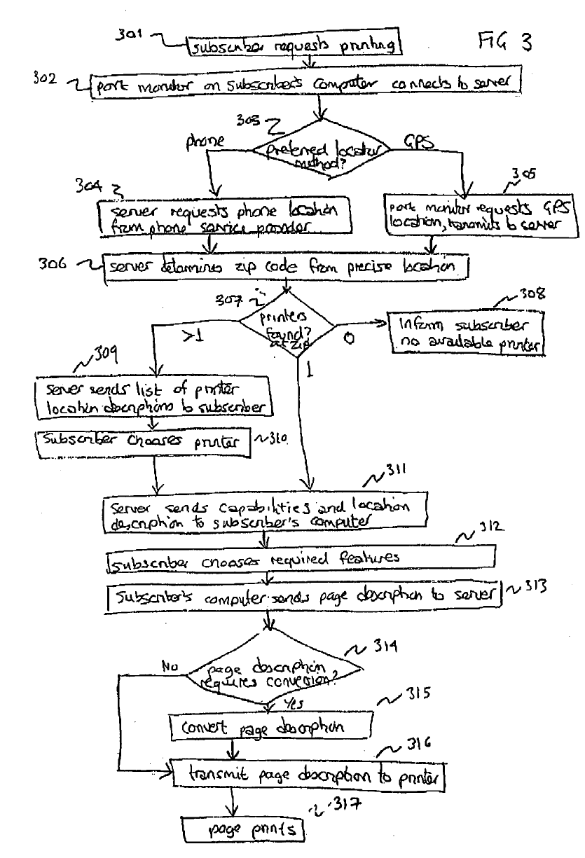

FIG. 3 is a flowchart illustrating the steps of the method of the invention. When subscribers request printing, they print to their pseudo-printer, as indicated in step 301. The printer-driver/port-monitor establishes a connection with the server and identifies the subscriber to the server, as indicated in step 302.

A check is made to determine whether the subscriber's preference is to determine their location via integrated GPS, as indicated in step 303. If the subscriber's preference is to determine their location via integrated GPS, the printer driver/port monitors the requests location information from the GPS receiver, and the location is transmitted across the Internet to the server, as indicated in step 305.

Alternatively, if the subscriber's preference is to use their cell-phone to identify their location, the server requests location information from the cell-phone service provider, using the phone number registered by the subscriber, as indicated in step 304.

When the location of the subscriber has been identified, the server 140 performs a search on the printers in its database, as indicated in step 306.

A database management system organizes the printers so that it is easy to compare their location with that of the subscriber. Explicit comparisons of the distance between the subscriber and printer is required only for printers located in the same zip code that the subscriber's location indicates they are present in. This is advantageous because finding all printers in the database with a specific zip code is a much quicker operation than performing distance calculations for all possible printers.

A check is made to determine whether a printer is found at the specific zip code, as indicated in step 307. If no printer that the subscriber is authorized to use is found, then the server 140 replies to the requesting computer with a message such as “no authorized printer found nearby” and no further processing is performed, as indicated in step 308.

If more than one authorized printer is found the server 140 responds and provides the subscriber with a list of printers to choose from, as indicated in step 309. The choices are made based on the descriptions supplied by the organization and stored in the database when the printer was initially added. A printer is then chosen by the subscriber, as indicated in step 310.

Typically, exactly one printer is located. In this case, the method of the invention proceeds to the next step immediately.

Once the printer has been identified, information about the capabilities of the printer is transmitted to the subscriber's computer so that the subscriber can select the required features, just as if the printer were connected directly, as indicated in step 311. The location of the identified printer is also transmitted, such as ‘at reception desk’, so that the user can know where to go to pick up the printed material. Here, the user has the opportunity to select a link to be provided with a map or plan of the location if the description of the location is not clear enough, as indicated in step 312.

The subscriber's computer then prepares a stream of PostScript language page description data as it would for a directly connected printer, as indicated in step 313. As the stream is produced, it is passed to the port monitor that passes it on to the server. The data includes information about the feature selections of the subscriber.

A check is made to determine whether the port monitor should encrypt the data stream as it is transmitted, as indicated in step 314. If this is the case, the port monitor encrypts and the server decrypts the data stream as it is received.

On receipt, the server passes the PostScript language stream to a PostScript language compatible interpreter. This recognizes the graphical commands to draw marks on the page contained in the stream and passes them to a printer driver selected according to the type of the identified printer. That printer driver naturally produces a page description in a form that the printer can understand, as indicated in step 315. The PostScript language stream is therefore translated into a graphical description specific to the identified printer.

Next, the server transmits the resulting graphical description to the printer at the Internet address supplied when the printer was added to the database, as indicated in step 316. In response, the printer prints the required pages, as indicated in step 317.

In certain embodiments, the server encrypts the data stream and the printer decrypts it for those printers that are capable of being programmed in the necessary way. Alternatively, if document privacy and security is deemed important, the server encrypts the resulting graphical description and transmits it to an ordinary computer in the organization's network. Software located at the organization is subsequently used to decrypt the stream and pass it on to the printer.

Although the invention has been described and illustrated in detail, it is to be clearly understood that the same is by way of illustration and example, and is not to be taken by way of limitation. The spirit and scope of the present invention are to be limited only by the terms of the appended claims.

What is claimed as new and desired to be protected by letters patent of the United States is:

1. A method for printing on a printer that is proximal to a subscriber having access to a database registry, comprising the steps of:
maintaining the database registry on a network by way of a server computer;
registering at least two printers with the database registry;
determining a location of the subscriber using a standard location-determining device in response to receiving a request for printing of a print job from a computer of the subscriber on one of the at least two printers registered with the database registry;
determining which printer of the at least two printers is most proximal to the subscriber; and
transferring the print job from the computer to the printer that is most proximal to the subscriber.

2. The method of claim 1, further comprising the steps of:
establishing a connection with the server and identifying the subscriber to the server;
determining whether the subscriber has a preference of how their location is determined; and
monitoring location request information from a GPS receiver in the computer if the preference of the subscriber is to determine their location by way of integrated GPS, otherwise requesting location information by way of the server from a cell-phone service provider using a number registered by the subscriber if the preference of the subscriber is to use a cell-phone to identify their location.

3. The method of claim 2, further comprising the step of:
searching a database in the server to locate a printer at the location of the subscriber.

4. The method of claim 3, wherein said searching step comprises the step of:
comparing distances between the subscriber and the at least two printers to determine the printer that is most proximal to the subscriber.

5. The method of claim 3, wherein said search is performed only for printers located in a zip code in which the subscriber is located.

6. The method of claim 3, further comprising the step of:
providing the subscriber with a message that informs the subscriber that no printers are at the location of the subscriber.

7. The method of claim 4, further comprising the step of:
sending a list of printer descriptions to the subscriber from the server if more than one printer is at the location of the subscriber.

8. The method of claim 1, wherein the subscriber chooses the printer on which to print.

9. The method of claim 3, further comprising the step of:
transmitting printer capability information to the computer.

10. The method of claim 9, wherein the subscriber chooses the capabilities of the printer based on the transmitted printer capability information.

11. The method of claim 9, further comprising the steps of:
choosing the capabilities of the printer based on the transmitted printer capability information; and
sending a page description to the server.

12. The method of claim 9, further comprising the steps of:
determining whether the page description requires conversion;
transmitting the page description to the printer if the page does not require conversion, otherwise converting the page description into a format suitable for printing on the printer and transmitting the converted page description to the printer if the page description requires conversion; and
printing a page on the printer.

13. The method of claim 1, wherein said maintaining step comprises adding or removing printers from the database.

14. The method of claim 13, further comprising the step of:
automatically determining the location of the printers when adding the printers to the database.

15. The method of claim 1, wherein said maintaining step comprises providing authorization for the subscriber to access the database.

16. The method of claim 1, further comprising the step of:
accessing the database to enroll an organization such that the organization can provide printing services;
entering details of the organization; and
storing the details of the organization in the database.

17. The method of claim 1, which comprises collecting the at least two printers into groups of related printers and classifying at least two printers into groups of related printers based on ownership of the at least two printers by specific organizations.

18. The method of claim 16, which comprises using the groups of related printers and classified groups of printers to permit or deny the subscriber access to the database.

19. The method of claim 1, wherein the server comprises a clusters of co-operating server computers.

20. The method of claim 1, wherein the server stores information about each subscriber that is subscribed to the system, each organization offering printing services, a geographical location data, and an Internet address for the at least two printers.

21. The method of claim 20, which comprises using the geographical location data for performing comparisons and plotting positions on a map.

22. The method of claim 21, wherein the geographical information is descriptive information for use by a person.

23. The method of claim 3, further comprising the step of:
informing the subscriber that no printer is available at their location.

24. The method of claim 3, further comprising the step of:
informing the subscriber of the printer location;
wherein the printer location comprises geographical map data.

25. The method of claim 9, wherein said choosing step comprises specifying a use of PostScript® language page description for use in printing the print job.

26. The method of claim 1, wherein the standard location-determining device is one of a GPS receiver and cell-phone triangulation.

27. A system for printing on a printer that is proximal to a subscriber, comprising:
a database containing a registry of subscribers and subscribing organizations;
a network connected to the database;
a server operatively coupled to the database;
at least two printers operatively coupled to the database by way of the network; and
a subscriber interface operatively coupled to the at least two printers by way of the network and at least one of a computer and a cell-phone, a location of said subscriber being determined by way of a standard location-determining device.

28. The system of claim 27, further comprising:
at least one organization computer connected to the network;
wherein the at least one computer is used by a subscribing organizations to access the database to enroll and enter details of the organization into the database such that the organization can provide printing services.

29. The method of claim 27, further comprising:
subscriber user devices operatively coupled to the network for permitting access to print services.

30. The system of claim 27, wherein the standard location-determining device comprises at least one of a GPS receiver and a device for performing cell-phone triangulation.
